(19) United States
(12) Patent Application Publication
(10) Pub. No.: US 2017/0046996 A1
(43) Pub. Date: Feb. 16, 2017

(54) LIGHT PROVIDED FROM COLOR ELEMENTS

(71) Applicant: Hewlett-Packard Development Company, L.P., Houston, TX (US)

(72) Inventors: Wei Kuang CHU, Taipei City (TW); Kuan-Ting WU, Taipei City (TW)

(21) Appl. No.: 15/305,280

(22) PCT Filed: Apr. 30, 2014
(86) PCT No.: PCT/US2014/035993

§ 371 Date: Oct. 19, 2016

(51) Int. Cl. G09G 3/20; G09G 3/36; G09G 3/34

(52) U.S. Cl. CPC G09G 3/2003; G09G 3/3413; G09G 3/3607; G09G 2320/0606; G09G 2354/00; G09G 2320/08

(57) ABSTRACT

A display apparatus includes at least one first color element selected from a red color element, a green color element and a blue color element, and at least one second color element selected from a white color element and a yellow color element. On the basis of an input, the amount of light provided from the at least one first color element is reduced while the amount of light provided prom the at least one second color element is increased.

### BACKGROUND

Color display devices typically include colored elements that individually addressable in order to present information in a visual form.

Red, green and blue color elements can be provided in the display devices, for example, which are each addressable to provide a respective colored light. Light provided from the different color elements can combine in accordance with an additive color model to give a visual percept of a spot of light at substantially any point across the color spectrum. In combination, multiple spots of light can form an image on the display device.

### BRIEF DESCRIPTION OF DRAWINGS

By way of non-limiting examples, methods and apparatus according to the present disclosure are described with reference to the following drawings, in which:

FIG. 1 illustrates example apparatus according to the present disclosure;

FIG. 2 illustrates example apparatus according to the present disclosure;

FIG. 3 illustrates example apparatus according to the present disclosure;

FIG. 4 illustrates example apparatus according to the present disclosure;

FIG. 5 illustrates an example method according to the present disclosure; and

FIGS. 6a to 6n illustrate example color element configurations according to the present disclosure.

### DESCRIPTION OF EMBODIMENTS

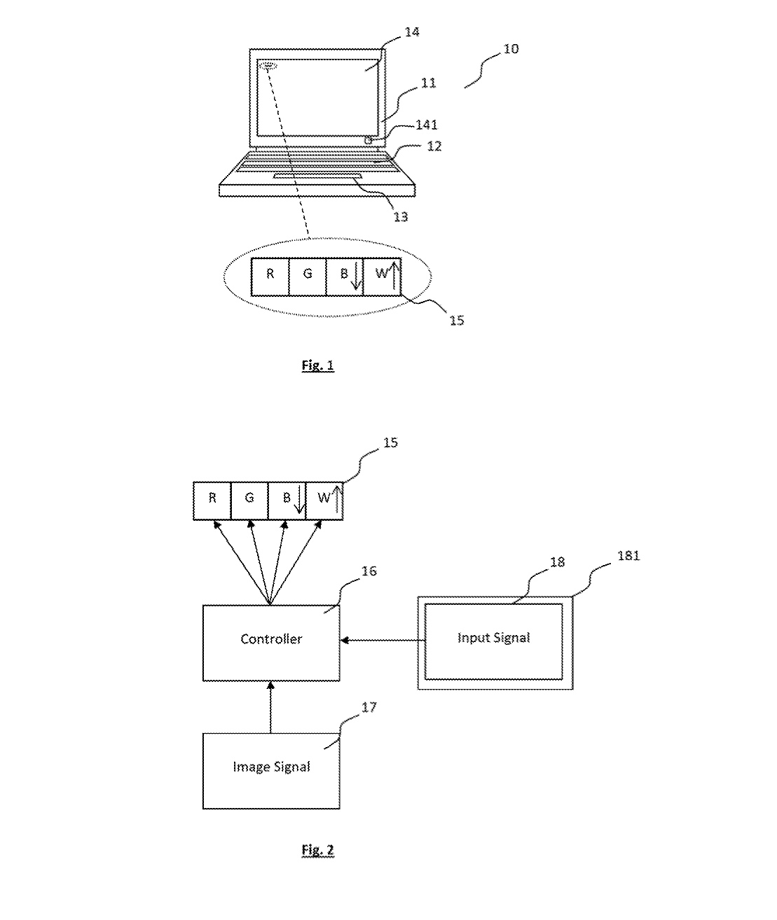

FIG. 1 illustrates a portable personal computing device 10, including a housing 11, a keyboard 12, a touchpad 13, and a color liquid crystal display (LCD display) 14. The personal computing device also includes a button 141 for adjusting settings of the display 14. The personal computing device 10 provides one example of display apparatus according to the present disclosure.

The LCD display 14 includes multiple individually addressable color elements, also described in respect of LCD displays and various other displays as subpixels or pixels.

The LCD display 14 includes red, green and blue subpixels. The red, green and blue color subpixels may each be considered a first color element. The red, green and blue subpixels are each addressable to provide a respective colored light. Light provided from the different subpixels can combine in accordance with an additive color model to give a visual percept of spot of light at substantially any point across the color spectrum.

In this example, the LCD display 14 includes a white backlight. The red, green and blue colored subpixels act as adjustable color filters, filtering light emitted from the backlight, such as to each transmit a specific frequency (color) of light only. In addition to red, green and blue subpixels, the LCD 14 display also includes white subpixels. Each white subpixel may be considered a second color element. The white subpixels do not substantially filter the color of the backlight, allowing transmission of white light therethrough. The inclusion of white subpixels may provide for an increase in display luminance at reduced power levels.

Red, green, blue and white subpixels (or color elements) are identified in the Figures by the letters “R”, “G”, “B”, and “W”, respectively. Multiple groups of adjacent red, green, blue and white subpixels can be provided. A group of adjacent red, green, blue and white subpixels may be considered a single pixel, e.g., a single RGBW pixel 15. Nonetheless, since the subpixels within such a group are individually addressable, and may combine with subpixels of other groups, subpixels may also be considered as individual, separate pixels,

While the example LCD display 14 illustrated in FIGS. 1 and 2 includes white subpixels, in an alternative example, as illustrated in FIGS. 3 and 4, an LCD display 14′ can include yellow subpixels instead of or in addition to white subpixels. Each yellow subpixel may be considered a second color element. Yellow subpixels (or color elements) are identified in the Figures by the letter “Y”. The example LCD display 14′ illustrated in FIGS. 3 and 4 is comprised in a portable personal computing device 10′, that also includes a housing 11, a keyboard 12, and a touchpad 13. The yellow subpixels act as adjustable color filters, filtering light emitted from a backlight such as to transmit yellow light only. In combination, each group of adjacent red, green, blue and yellow subpixels may be considered a single pixel, e.g. a single RGBY pixel 15′. Nonetheless, since the subpixels within such a group are individually addressable, and may combine with subpixels of other groups, subpixels may also be considered as individual, separate pixels.

The personal computing devices 10, 10′ illustrated in FIGS. 1 to 4 each include a controller 16 for addressing and controlling light transmission from the red, green and blue, and white or yellow, subpixels. The controller 16 receives an image signal 17, the image signal 17 being indicative of an image to be represented on the display 14, 14′. The image signal 17 is also indicative of mode for addressing, and for causing different amounts of colored light to be provided from, the subpixels, in order to present the image on the display 14, 14′. The image signal 17 may be derived from a variety of sources, such as a DVD player, television signal, computer memory or otherwise.

Each of the subpixels in the LCD display 14, 14′ includes polarizing elements and a liquid crystal positioned between the polarizing elements. The amount of light provided from each subpixel can be adjusted by changing an amount of voltage supplied to the liquid crystal to change a tilt angle of the liquid crystal. Changing the tilt angle of the liquid crystal controls the amount of light provided from the subpixels through one of the polarizing elements.

In the example illustrated in FIGS. 1 and 2, the personal computing device 10 includes a user interface 181 to deliver an input signal 18 to the controller 16. The user interface may include the button 141, for example. A user may provide an external input to the controller 16 by pressing the button 141, whereupon the input signal 18 is transmitted from the user interface 181 to the controller 16. In other examples, the user interface may be provided by a keyboard, touchpad, mouse, remote control, microphone or by another means that can receive an external input from a user (e.g. a button press, key press, touch, voice command or otherwise) and transmit an input signal to a controller upon receipt of the external input.

In the example illustrated in FIGS. 1 and 2, upon receipt of the input signal 18, the controller 16 reduces the amount of light to be provided from at least one of the red, green and blue subpixels and increases the amount of light to be provided from the white subpixel.

In the alternative example illustrated in FIGS. 3 and 4, the personal computing device 10′ includes an automation unit 182 for providing the input signal 18 to the controller 16. The automation unit 182 determines if the display apparatus 10′ or display 14′ has been switched on for a predetermined period of time (e.g. 30 minutes, 1 hour, or 2 hours, etc.) and, if it has been switched on for the predetermined period of time, delivers the input signal 18 to the controller 16 automatically. In alternative examples, the automation unit may include one or more sensors to monitor surrounding conditions, such as ambient light, and may transmit the input signal to the controller on the basis of the monitored conditions.

In the example illustrated in FIGS. 3 and 4, upon receipt of the input signal 18, the controller 16 reduces the amount of light to be provided from at least one of the red, green and blue subpixels and increases the amount of light to be provided from the yellow subpixel.

In the examples, the controller may reduce, for example, the amount of light to be provided from at least, or from only, the blue subpixel, while it increases the amount of light to be provided from the white subpixel or yellow subpixel. This change in the amount of light (change in brightness) of a subpixel is illustrated in FIGS. 1 to 4, for example, using upwardly and downwardly directed arrows.

In examples of the present disclosure, the degree by which the amount of light provided from at least one first color element (selected from a red, green and blue color element) is reduced may correspond to the degree by which the amount of light provided from at least one second color element (selected from a white and yellow color element) is increased. Alternatively, the degree by which the amount of light provided from the at least one first color element is reduced may be different to the degree by which the amount of light provided from the at least one second color element is increased. In the examples, the amount of light provided may be increased or decreased by e.g., greater than 5%, greater than 10%, greater than 25% or greater than 50%; or between 5 and 100%, between 25 and 75%, or between 25 and 60%; or about 10%, about 25%, about 50% or about 100%; or otherwise.

Increasing the amount of light provided from a color element may be achieved, for example, by increasing the voltage or current supply to the color element, and reducing the amount of light provided from a color element may be achieved, for example, by reducing the voltage or current supply to the color element.

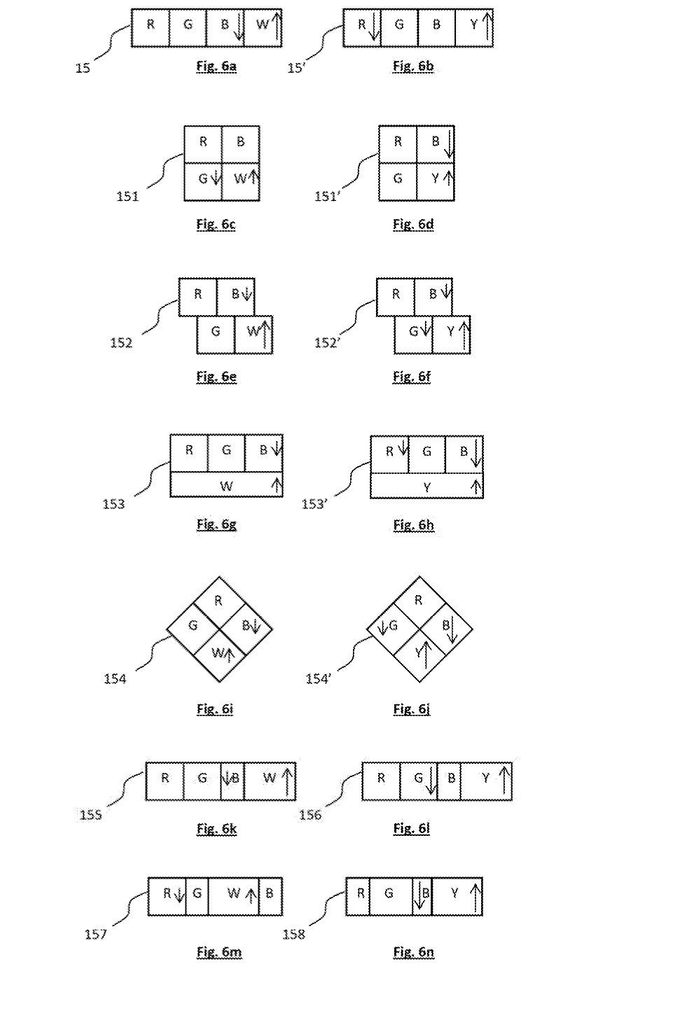

In the Figures, an upwardly directed arrow on a subpixel or color element is provided to indicate an increase in the amount of light provided from that subpixel or color element and a downwardly directed arrow on a subpixel or color element is provided to indicate a reduction in the amount of light provided from that subpixel or color element. In FIGS. 6a to 6n, discussed further below, the different lengths of the arrows are indicative of the different degrees by which the amount of light provided from the subpixel or color element is increased or reduced (the longer the arrow, the greater the degree).

Since the amount of light provided from the at least one first color element is reduced while the amount of light provided from the at least one second color element is increased, in some examples, the total amount of light provided from a group containing the first and second color elements can be substantially maintained.

By virtue of the input signal, whether transmitted following a direct action of a user or automatically, the controller may switch between a first mode (e.g., a “normal mode”) and a second mode (e.g., a “modified mode”). In the second mode, for an identical image signal, the controller will cause less light to be provided from the at least one first color element than in the first mode, and will cause more light to be provided from the at least one second color element than in the first mode. As an example, for the identical image signal, the controller may cause less light to be provided from at least, or from only, the blue color element than in the first mode, and cause more light to be provided from the white and/or yellow color element than in the first mode. The modified mode may be considered an eye protection mode.

The second mode may be modifiable to change the degree by which the amount of light provided from the at least one first color element is reduced and/or by which the amount of light provided from the at least one second color element is increased. In one example, the amount of light provided from the at least one first color element (e.g., from the blue element) is reduced by 25%. while the amount of light provided from the at least one second color element is increased by 25%. In another example, the amount of light provided from the at least one first color element (e.g., from the blue color element) is reduced by 50%, while the amount of light provided from the at least one second color element is increased by 50%. In another example, the amount of light provided from the at least one first color element (e.g., from the blue color element) is reduced by 50%, while the amount of light provided from the at least one second color element is increased by 25%. Nevertheless, the change in the amount of light is not limited to a 50% change or a 25% change; the change in the amount of light of any color element may be any change that is greater than 0%. In one example, the amount of light provided from the at least one first color element (e.g. from the blue color element) may be reduced to zero, and the amount of light provided form the at least one second color element may be increased from zero.

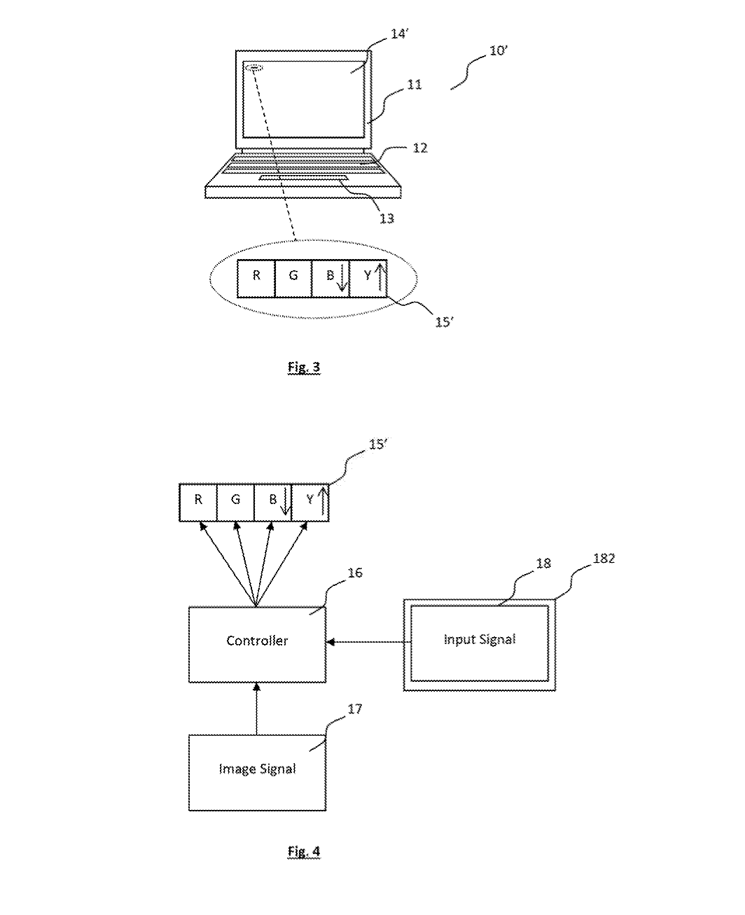

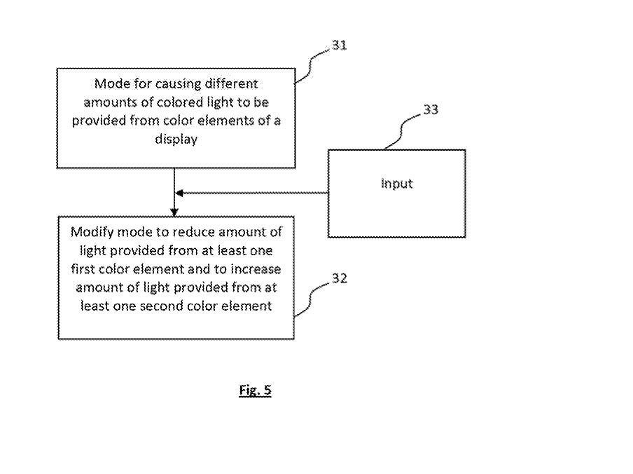

An example method of displaying an image according to the present disclosure is illustrated in FIG. 5. At item 31, the method includes a mode for causing different amounts of colored light to be provided from color elements of a display. At item 32, the method includes modifying the mode in response to an input 33 so that the amount of light provided from the at least one first color element is reduced and the amount of light provided from the at least one second color element is increased. The method may also include displaying the image in accordance with the modified mode.

The mode may comprise machine readable instructions that are coded in an image sign and/or in data storage devices. Storage devices may be comprised in the controller and/or elsewhere in the apparatus and may include suitable computer readable media such as volatile (e.g. RAM) and/or non-volatile e.g. ROM, disk) memory or otherwise.

Techniques described herein may be applied to a variety of different display apparatuses comprising a variety of different types of electronic displays. Some example displays that may be used in accordance with the present disclosure include LCD, LED, OLED, PLED, Plasma, and color bi-stable displays (E-ink/cholesteric/memory (MEM) displays). The displays may include multiple color elements to build an image based on an additive color scheme. The color elements may be individually addressable and may be identifiable as subpixels, pixels or otherwise. Color elements may “provide” iight, or light may be “provided from” color elements, by virtue of light emission by the color elements, light transmission through the color elements and/or light reflection by the color elements, for example. Increasing the amount of light provided from color elements in these displays may be achieved by increasing the voltage or current supply to the color elements, and reducing the amount of light provided from the color elements may be achieved by reducing the voltage or current supply to the color elements. In OLED displays, for example, an amount of fluorescence and phosphorescence is controlled by changing an amount of current supplied to color elements. Display apparatus according to the present disclosure may include notebooks, laptops, tablets, computer monitors, smartphones, televisions, e-book readers, or otherwise.

Prolonged use of color displays can cause harm to a user's eye and/or cause discomfort. For example, light from the display can irritate the eye or cause headaches. In some instances, the light can cause or contribute to onset of eye disease or a premature aging eye problem. Chronic damage to the macular of the eye is a possibility. The degree of harm and/or discomfort is dependent not only on the duration and intensity of light incident on the eye, but also on the wavelength of light incident on the eye. For example, prolonged and/or intense exposure to blue light has been considered to be particularly detrimental to eye health. Since the controller can reduce the amount of light provided from particular color elements, e.g., blue color elements, and replace this with light from white and/or yellow color elements, discomfort and/or harm to the eye may be reduced or eliminated by apparatus and methods of the present disclosure. At the same time, image quality that is acceptable to the user may be maintained.

While example apparatus and methods of the present disclosure may cause a change in color of the displayed image that is perceivable by the user, the reduction in discomfort and/or harm may provide for better user experience overall.

Display apparatus in accordance with the present disclosure, which may display an image based on an image signal, may include, for example: a group of color elements (e.g. colored pixels or subpixels), that include at least one first color element selected from a red color element, a green color element and a blue color element, and at least one second color element selected from a white color element and a yellow color element; a controller to individually address the color elements and control an amount of light to be provided from each color element in accordance with the image signal; wherein, on receipt of an input signal by the controller, the controller reduces the amount of light to be provided from the at least one first color element in accordance with the image signal while it increases the amount of light to be provided from the at least one second color element in accordance with the image signal.

Display apparatus in accordance with the present disclosure may include, for example: at least one first color element selected from a red color element to provide red light, a green color element to provide green light and a blue color element to provide blue light; and at least one second color element selected from a white color element to provide white light and a yellow color element to provide yellow light; and a controller to control the amount of light provided from each color element in accordance with an image signal and changeable between a first mode and a second mode, wherein, in the second mode, for an identical image signal, the controller controls the color elements so that less light is provided from the at least one first color element than in the first mode, and more light is provided from the at least one second color element than in the first mode.

A method of displaying an image according to the present disclosure may include, for example: receiving an input to modify; and in response to the input, modifying a mode for causing different amounts of colored light to be provided from color elements of a display, the color elements comprising: at least one first color element selected from a red color element a green color element and a blue color element; and at least one second color element selected from a white color element and a yellow color element; such that the amount of light provided from the at least one first color element is reduced while the amount of light provided from the at least one second color element is increased.

Software that provides machine readable instructions may also be provided that, when installed on a computing device connected to a display and executed by a processing device, causes the computing device to perform the above method of displaying an image.

Color elements used in apparatus and methods according to the present disclosure may be arranged in a variety of different configurations. For example, in the LCD display 14 illustrated in FIGS. 1 and 2, and as also illustrated in FIG. 6a, a group of red, green, blue and white (RGBW) subpixels or color elements 15 are arranged in a single row, thus providing a stripe configuration. Similarly, in the LCD display 14′ illustrated in FIGS. 3 and 4, and as also illustrated in FIG. 6b, a group of red, green, blue and yellow (RGBY) subpixels or color elements 15′ are provided in a stripe configuration. In alternative examples, color elements within groups 151, 151′, 152, 152′ can be arranged in different rows, e.g. in a matrix configuration such as a 2×2 matrix as illustrated, for example, in FIGS. 6c to 6f. This matrix configuration may be a PenTile™ matrix. In the matrix configuration, color elements of one row may be aligned with color elements of an adjacent row (see FIGS. 5c and 6d, for example), or color elements of one row may be offset from color elements of an adjacent row (see FIGS. 6e and 6f, for example). In alternative examples, groups of color elements 153, 153′ may be provided in which red, green and blue color elements are in one row, with the white or yellow color elements in an adjacent row (see FIGS. 6g and 6h, for example). This configuration may be considered a PenTile-like matrix configuration. In other examples, groups of color elements 154, 154′ may be provided in which the color elements are in a diamond configuration (see FIGS. 6i and 6j, for example).

The color element configurations may each take a homogenous form or an inhomogeneous form in inhomogeneous form, color elements are not all of the same size and/or shape (i.e. one of the color elements has a size and/or shape that is different from another of the color elements). FIGS. 6k to en illustrate examples of groups of color elements 155, 156, 157, 158 having inhomogeneous stripe configurations. On the contrary, in homogenous form, groups of color elements have color elements that are all of the same size and shape. FIGS. 6a to 6f, 6i and 6j illustrate examples of groups of color elements having homogeneous form.

Example approaches to adjusting the amount of light provided from color elements are illustrated in 6a to 6n using the upwardly and downwardly directed arrows. As can be seen, in some example approaches, the amount of light provided from only one of the red, green and blue color elements is reduced, or the amount of light provided from only two of the red, green and blue color elements is reduced. In some example approaches, the degree by which the amount of light provided from each of the red, green and blue color elements in which a reduction takes place is reduced corresponds to the degree by which the amount of light from the white or yellow color element is increased. In other examples, the degree by which the amount of light provided from each of the red, green and blue color elements in which a reduction takes place is reduced does not correspond to degree by which the amount of light provided from the white or yellow color element is increased. While different example approaches are illustrated in FIGS. 6a to 6n with respect to certain color elements configurations, the approaches are not limited to use with those configurations only. Each example approach for reducing and increasing amounts of light provided from color elements illustrated in FIGS. 6a to 6n can be applied to any one of the illustrated color element configurations. Further, a variety of other example approaches for reducing and increasing amounts of light from color elements are possible.

Throughout this specification the words “comprising” and “including” or variations such as “comprise”, “comprises, “include”, and “includes”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the above-described embodiments, without departing from the broad general scope of the present disclosure. The present examples are, therefore, to be considered in all respects as illustrative and not restrictive.

1. A display apparatus to display an image in accordance with an image signal the apparatus comprising:
a group of color elements comprising:
at least one first color element selected from a red color element, a green color element and a blue color element; and
at least one second color element selected from a white color element and a yellow color element;
a controller to individually address the color elements and control an amount of light to be provided from each color element in accordance with the image signal:
wherein, on receipt of an input signal by the controller, the controller reduces the amount of light to be provided from the at least one first color element in accordance with the image signal while it increases the amount of light to be provided from the at least one second color element in accordance with the image signal.

2. The apparatus of claim 1, wherein the at least one first color element comprises the blue color element and, on receipt of the input signal, the amount of light to be provided from the blue color element is reduced.

3. The apparatus of claim 1, wherein the controller is to maintain a total amount of light to be provided by the at least one first color element and at least one second color element when the amount of light to be provided from the at least one first color element is reduced while the amount of light to be provided from the at least one second color element is increased.

4. The apparatus of claim 1, wherein the apparatus further comprises a user interface, and the input signal is transmitted from the user interface to the controller.

5. The apparatus of claim 4, wherein the user interface is selected fro a keyboard, a touchpad, a remote control and a microphone.

6. The apparatus of claim 1, wherein the apparatus further comprises an automation unit, and the input signal is provided to the controller by the automation unit

7. The apparatus of claim 6, wherein the input signal is provided to the controller by the automation unit if the automation unit determines that the display apparatus has been on for a predetermined period of time.

8. The apparatus of claim 1, wherein the group of color elements is a pixel selected from an RGBW pixel and an RGBY pixel.

9. The apparatus of claim 1, wherein the group of color elements is in a stripe configuration.

10. The apparatus of claim 1, wherein the group of color elements is in a matrix configuration.

11. A display apparatus comprising:
at least one first color element selected from a red color element to provide red light, a green color element to provide green light, and a blue color element to provide blue light;
at least one second color element selected from a white color element to provide white light and a yellow color element to provide yellow light: and
a controller to control an amount of light provided from the at least one first color element and the at least one second color element in accordance with an image signal,
wherein controller is changeable between a first mode and a sec end mode, and
wherein, in the second mode, for an identical image signal, the controller is to control the color elements so that less light is provided from the at least one first color element than in the first mode, and more lights provided from the at least one second color element than in the first mode.

12. The apparatus of claim 11,
wherein the at east one first color element comprises the blue color element, and
wherein, in the second mode, for the identical image signal, the controller controls the blue color element so that less light is provided from the blue color element than in the first mode.

13. The apparatus of claim 12, wherein the second mode is an eye protection mode.

14. A method of displaying an image on a display, comprising:
receiving an input to modify; and
in response to the input, modifying a mode for causing different amounts of colored light to be provided from color elements of a display, the color elements comprising:
at least one first color element selected from a red color element, a green color element and a blue color element; and
at least one second color element selected from white color element and a yellow color element;
wherein the amount of light provided from the at least one first color element is reduced while the amount of light provided from the at least one second color element is increased.

15. The method of calm 14, wherein the receiving and the modifying are performed by a processing device within a computing device.
